(19) United States
(12) Patent Application Publication
(10) Pub. No.: US 2026/0086183 A1
(43) Pub. Date: Mar. 26, 2026

(54) GUIDANCE SYSTEM FOR AIRCRAFT

(71) Applicant: Skyway Technologies Corp., Pleasanton, CA (US)

(72) Inventors: Clifford FERNANDEZ, New York, NY (US); Derrick Harry Lewis, New York, NY (US)

(21) Appl. No.: 19/342,215

(22) Filed: Sep. 26, 2025

Related U.S. Application Data
(60) Provisional application No. 63/699,421, filed on Sep. 26, 2024.

(51) Int. Cl. G01S 1/08; B64F 1/00; G08G 5/26; G08G 5/54; G08G 5/57; G08G 5/76

(52) U.S. Cl. CPC G01S 1/08; B64F 1/00; G08G 5/26; G08G 5/54; G08G 5/57; G08G 5/76

(57) ABSTRACT

Systems and methods for autonomously guiding aircraft are described. The systems and methods may provide a final approach and take off area (FATO) with a guidance system, such as an autonomous approach guidance system, which is configured to facilitate the navigation of the aircraft onto (or out of) the FATO. For example, a FATO may include one or more beacons that assist in the navigation or guidance of aircraft as the aircraft approach and land at the FATO. The guidance system may utilize the beacons, which may include approach beacons and adjustment beacons, to provide information to the aircraft that facilitates a proper approach and landing by the aircraft to or on the FATO.

### CROSS-REFERENCE TO RELATED APPLICATIONS

This application claims priority to U.S. Provisional Patent Application No. 63/699,421 , filed on Sep. 26, 2024, entitled GUIDANCE SYSTEM FOR AIRCRAFT, which is hereby incorporated by reference in its entirety.

### BACKGROUND

UAVs (Unmanned Aerial Vehicles), such as vertical take-off and landing (VTOL) aircraft (e.g., electric VTOLs, or eVTOLs), have many different uses, including surveillance, package delivery, remote sensing, exploration and monitoring of locations, construction and surveying applications, and so on.

Often, eVTOLs and other aircraft take off from and land onto final approach and takeoff areas (FATOs). A FATO may be an obstacle free area to which the aircraft target a final approach and landing and/or begin a flight (e.g., take off) or departure. Thus, improvements to FATOs may enable eVTOLs and other aircraft to be safety used and deployed in a variety of scenarios and applications.

### BRIEF DESCRIPTION OF THE DRAWINGS

FIG. 1 is a diagram illustrating an example guidance system for eVTOL aircraft.

FIG. 2 is a diagram illustrating an example FATO having multiple guidance beacons.

FIG. 3 is a flow diagram illustrating an example method for adjusting an operation of an eVTOL.

FIG. 4 is a flow diagram illustrating an example method for transmitting information to an eVTOL.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Systems and methods for autonomously guiding aircraft, such as eVTOLs or other UAVs, are described. The systems and methods may provide a FATO with a guidance system, such as an autonomous approach guidance system, which is configured to facilitate the navigation of the aircraft onto (or out of) the FATO.

In some cases, issues may arise when landing unmanned aircraft, such as in areas with short approach zones and/or ever changing wind or other environmental patterns. Thus, a FATO employing the guidance system described herein may improve the navigation and guidance of aircraft in a dynamic or continuous manner, improving the safety and/or efficiently of the operations of the aircraft, among other benefits.

For example, a FATO may include one or more beacons that assist in the navigation or guidance of aircraft as the aircraft approach and land at the FATO (or take off from the FATO). The guidance system may utilize the beacons, which may include approach beacons and adjustment beacons, to provide information to the aircraft that facilitates a proper approach and landing by the eVTOL onto the FATO.

In the following description, for the purposes of explanation, numerous specific details are set forth in order to provide a thorough understanding of implementations of the present technology. It will be apparent, however, to one skilled in the art that implementations of the present technology can be practiced without some of these specific details. The phrases “in some implementations,” “according to some implementations,” “in the implementations shown,” “in other implementations,” and the like generally mean the particular feature, structure, or characteristic following the phrase is included in at least one implementation of the present technology and can be included in more than one implementation. In addition, such phrases do not necessarily refer to the same implementations or different implementations.

### Examples of the Autonomous Approach Guidance System

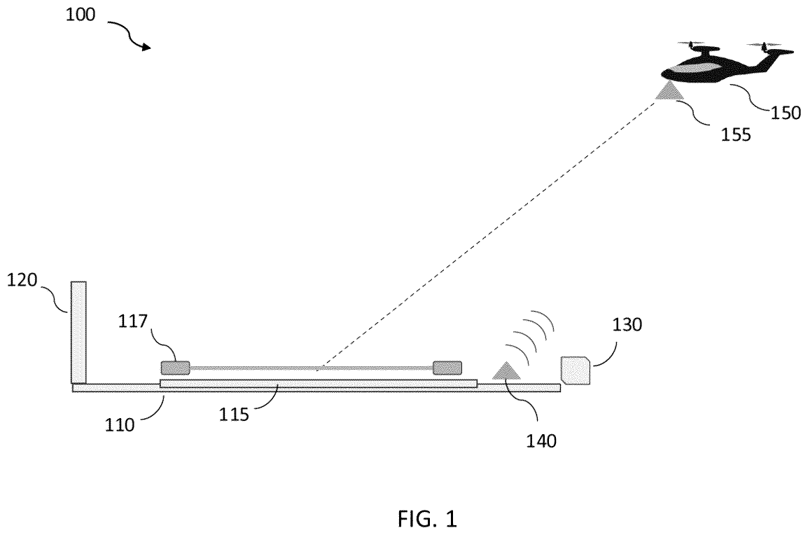

As described herein, the systems and methods provide an autonomous approach guidance system, which can be deployed at a FATO to facilitate and/or manage the approach and landing of aircraft (e.g., eVTOLs) at the FATO. FIG. 1 is a diagram illustrating a guidance system 100 for eVTOLs.

A FATO 110, which may be part of a vertiport, can include a touch-down and lift-off area (TLOF) 115 that is centered within an area defined by the FATO 110. The TLOF 115 may be identified by one or more laser bridge sensors 117. The FATO 110 may also include a wind cone 120 or other weather devices or sensors, cameras 130 or other imaging components, as well as lighting, safety nets, and so on.

Further, the FATO 110 (or vertiport) includes one or more navigation or guidance beacons 140, which transmit information to approaching aircraft, such as an eVTOL 150. The eVTOL 150 includes a receiving component or device, such as a receiving beacon 155, as well as other navigation devices. For example, the receiving beacon 155 may be paired with the beacon 150 of the FATO 110, such that it receives information from the beacon 150 when the eVTOL 150 is within a certain distance (e.g., ˜300 feet or less) to a front area of the FATO 110.

The beacon 150 may transmit a unique identifier, such as an identifier for the beacon 150, FATO 110, TLOF 115, and so on, as well as data associated with the FATO 110 and/or the current approach/landing of the eVTOL 150 to the FATO 110.

For example, the beacon 150 may transmit a FATO ID, information that identifies a current status of the TLOF 115 (e.g., “pad clear” status information), weather information (e.g., wind, precipitation, temperature, and so on), an approach lane or navigation channel for the eVTOL (e.g., a landing path), and so on.

The eVTOL 150 receives the information via the receiving beacon 155 and modifies its current operation (e.g., approach and landing) based on the received information. In some cases, the FATO 110 may transmit additional or updated information, such as at certain time intervals, when the eVTOL approaches and/or moves to certain distances (e.g., 200 feet, 100 feet, 50 feet, and so on) from the FATO 110.

For example, when the weather is dynamically or incrementally changing (e.g., there is a swirling wind), the FATO 110, via the beacon 140, may transmit updated guidance or navigation information to the eVTOL 150. The eVTOL 150 may then adjust its operation based on the received information.

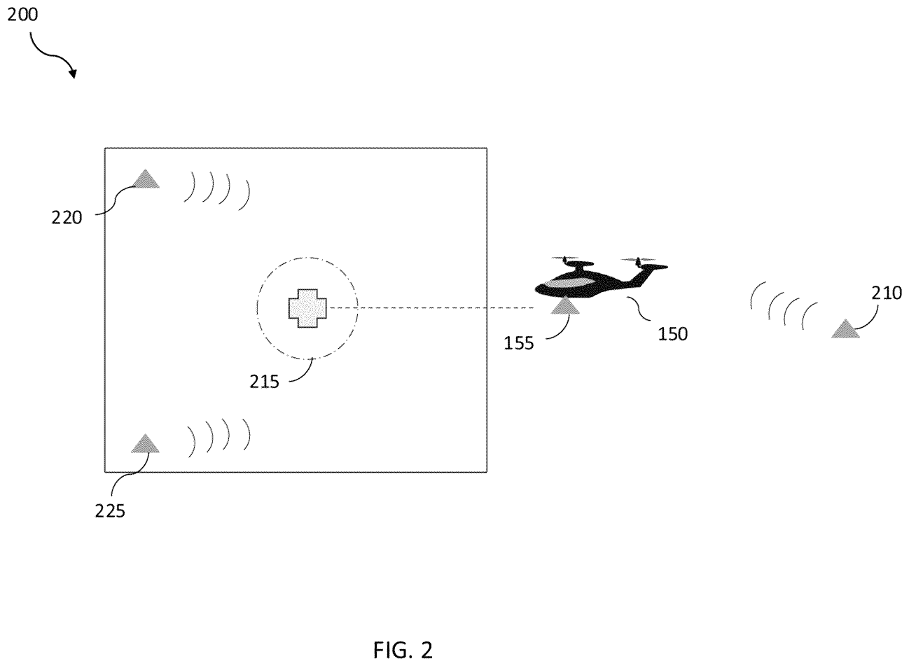

In some examples, a FATO may include various configurations of beacons that facilitate the guidance of aircraft to the FATO 110 and/or the TLOF 115. FIG. 2 depicts a FATO 200 having multiple deployed beacons. The beacons may be similar to the beacon 140 and transmit information to aircraft during approaches to the FATO 200.

The FATO 200 includes an approach beacon 210, similar to the beacon 140, which facilitates the communication of information about the FATO 200 and/or a current approach/landing for the eVTOL 150.

The FATO 200 also includes multiple adjustment beacons, such as a right adjustment beacon 220 and a left adjustment beacon 225, which communicate with the eVTOL 150 (e.g., via its receiving beacon 155) to guide the eVTOL 150 to land on a TLOF 215 of the FATO 210. In some cases, the adjustment beacons 220, 225 provide target information to the eVTOL 150 that identifies or depicts certain distances to the right or left of the TLOF 215 during the approach and landing.

In some cases, a landing location (e.g., the center of the TLOF 215) may be associated by a variable (e.g., a center variable represented by center =(RT+=, LT+=, CT−=). The beacons 220, 225 may transmit (e.g., send pings) information or metadata to the eVTOL 150 that includes the following information for the landing location: (left/right/center, landing#). The beacons 220, 225 may ping the eVTOL 150 at certain intervals (e.g., one ping per second), and/or propagate or transmit information at a constant periodicity and/or Var.

In an example scenario, the eVTOL 150 approaches the TLOF 215 and passes the approach beacon 210. The TLOF 215 is represented by a center variable of (+17, +17, −34), where the values are distances from the center of the TLOF 215 to the different beacons 210, 220, 225. During the approach, the eVTOL 150 receives a ping every second (or at other rates) that indicate its location with respect to the three beacons 210, 220, 225.

If the eVTOL 150 moves closer to the right adjustment beacon 220, the ping may include a position representation as (+10, +24, −15), where the values are in feet, meters, or other units. As the eVTOL 150 moves back towards the center, the position representation may adjust to (+16, +18, —25). In some cases, the eVTOL 150 may be within a certain safety margin or buffer (e.g., ˜D), which provides for a distance margin in each direction with respect to the center variable.

Thus, in some examples, a guidance system associated with the FATO 200 includes at least one approach beacon and one or more adjustment beacons, where the beacons operate to communicate with the eVTOL 150 regarding its approach (e.g., identification of FATO 200, authentication of eVTOL, weather information, and so on), as well as landing guidance information with respect to landing the eVTOL 150 on the TLOF 215. While depicted as two beacons, the guidance system may deploy one single beacon (e.g., in one of the corners of the FATO 200) or more beacons (e.g., a beacon in each of the four corners of the FATO 200).

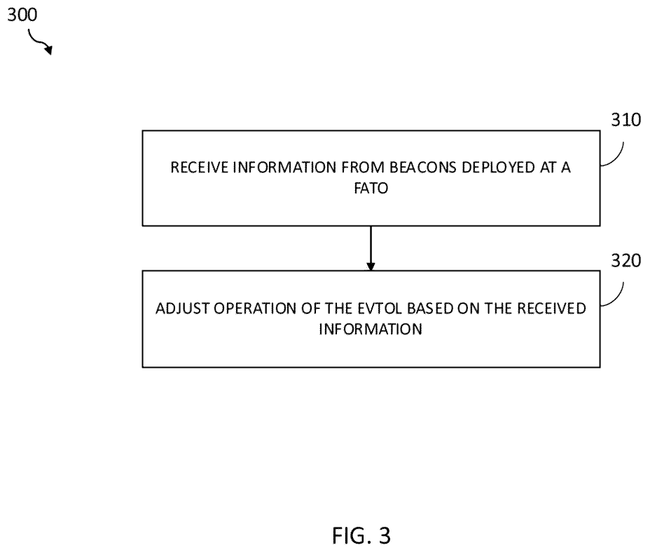

An eVTOL (e.g., the eVTOL 150), or other aircraft, may perform various processes or methods when landing on a TLOF or other landing pad. FIG. 3 is a flow diagram illustrating a method 300 for adjusting an operation of an eVTOL. The method 300 may be performed by the eVTOL and, accordingly, is described herein merely by way of reference thereto. It will be appreciated that the method 300 may be performed on any suitable hardware.

In operation 310, the eVTOL (via an internal guidance or navigation system) receives information from a group of beacons that identifies a center of a FATO (or a TLOF of the FATO). For example, the eVTOL 150 may receive information from the approach beacon 210 and/or the adjustment beacons 220, 225 of the FATO 200 after moving within a certain distance of the center of the FATO 200.

In operation 320, the eVTOL 150 adjusts its operation (e.g., approach path or trajectory) based on the information. For example, based on position information within the received information, the eVTOL 150 adjusts its trajectory to move back towards a center of the FATO 200 (or within a landing zone that includes the center).

As described herein, the eVTOL 150 may receive information in intervals (e.g., one second intervals) and/or based on its distance to the FATO 200. For example, the eVTOL may receive from the group of beacons 210, 220, 225, information that identifies the position of the eVTOL 150 with respect to or relative to the center of the TLOF 215 at multiple different time- and/or distance-based intervals, and adjusts its operation based on the new or updated information. The eVTOL may continue to perform adjustments until it lands on the TLOF 215.

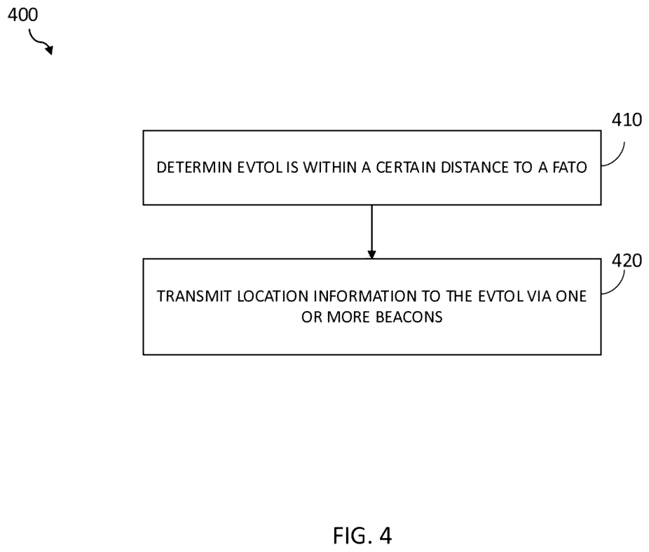

In some examples, a guidance system of the FATO 100 or 200 may perform various processes or methods when providing information to the eVTOL 150 during an approach and/or landing. FIG. 4 is a flow diagram illustrating a method 400 for transmitting information to an eVTOL. The method 400 may be performed by the guidance system and, accordingly, is described herein merely by way of reference thereto. It will be appreciated that the method 400 may be performed on any suitable hardware.

In operation 410, the guidance system determines that an eVTOL is within a certain distance to a center of a FATO. For example, a guidance system associated with the FATO 200 may determine the eVTOL 150 has passed the approach beacon 210 of the FATO 200.

In operation 420, the guidance system transmits location information to the eVTOL. For example, the guidance system, via the group of beacons 210, 220, 225, transmits information to the eVTOL 150 that indicates a position of the eVTOL relative to a center of the FATO 200, such as information that identifies a position of the eVTOL to one or more of the adjustment beacons 220, 225.

In some cases, the guidance system transmits the location information to the eVTOL 150 based on a variety of triggers or events, including:
an eVTOL 150 being at or within a certain distance to a FATO and/or different areas (e.g., a center area) of the FATO;
time intervals (e.g., one second intervals) associated with transmitting information (e.g., updated information) to the eVTOL 150;
a change in certain weather or environmental conditions (e.g., a gust of wind at an area below the eVTOL 150 and/or close to the center of a FATO;
a determination that a trajectory of the eVTOL 150 is outside of an expected or predicted trajectory to the center of the FATO, where the expected or predicted trajectory may be based on known or previous landings for the eVTOL 150 (or a similar make/model of the eVTOL) and/or a baseline trajectory for eVTOLs at the FATO;
a determination of a hazardous situation at the FATO, such as due to other aircraft, weather, network or air traffic control issues, and so on; and so on.

Thus, the guidance system, when deployed by or for a FATO (e.g., the FATO 100, 200) may facilitate the transmission of guidance information to approaching aircraft, such as the eVTOL 150. Using the guidance information, the aircraft may adjust, modify, and/or optimize their approach and landing at the FATO.

### Examples of the Disclosed Technology

The disclosed technology, such as the guidance system, may be implemented as a variety of examples or embodiments.

For example, a FATO may include a TLOF area having a center area and one or more guidance beacons that transmit information to aircraft proximate to the TLOF area of the FATO.

In some cases, the one or more guidance beacons include an approach beacon configured to transmit information to the aircraft when the aircraft is within a certain distance to the center area of the TLOF area and one or more adjustment beacons configured to transmit target information to the aircraft.

In some cases, the target information includes information that indicates a relative position of the aircraft to the center area of the TLOF area and the one or more adjustment beacons.

In some cases, the one or more adjustment beacons include a right adjustment beacon and a left adjustment beacon, and wherein the target information includes a position representation that indicates a position of the aircraft relative to the approach beacon, the right adjustment beacon, and the left adjustment beacon.

In some cases, the one or more guidance beacons include multiple adjustment beacons positioned at a peripheral area of the TLOF area and configured to transmit target information to the aircraft.

In some cases, the target information includes distance information that represents a position of the aircraft with respect to a right side or a left side of a center line of the TLOF area.

In some cases, the one or more guidance beacons include an approach beacon configured to transmit information to the aircraft when the aircraft is within a certain distance to the center area of the TLOF area, where the information includes a unique identifier for the FATO or the TLOF area.

In some cases, the information includes information associated with a current status of the FATO and navigation lane information associated with an approach to be taken by the aircraft to the center area of the TLOF.

In some cases, the FATO includes a weather sensor, and where the one or more guidance beacons transmit weather information captured by the weather sensor to the aircraft.

In some cases, the weather sensor is a wind speed sensor, and wherein the weather information includes wind speed information for multiple areas proximate to the center area of the TLOF area.

In some examples a method performed by a guidance system of a FATO includes determining that an aircraft approaching the FATO is within a certain distance to a center of the FATO and transmitting location information to the aircraft that represents a location of the aircraft relative to the center of the FATO.

In some cases, the method includes determining an occurrence of an information transmission event at the FATO and transmitting updated location information to the aircraft.

In some cases, the occurrence of an information transmission event at the FATO includes an event where the aircraft has crossed a distance threshold while approaching the FATO.

In some cases, the information transmission event at the FATO includes a commencement of a time period for transmission of updated location information to the aircraft.

In some cases, the occurrence of an information transmission event at the FATO includes a change in weather at the FATO.

In some cases, the occurrence of an information transmission event at the FATO includes a determination that a current trajectory of the aircraft is outside of an expected trajectory for the aircraft while approaching the FATO.

In some cases, the location information includes information that identifies a position of the aircraft to one or more of adjustment beacons positioned at the FATO.

In some cases, the guidance system transmits the location information to the aircraft via an approach beacon deployed at a front area of the FATO.

In some examples, a method performed by an aircraft includes receiving information from a beacon of a FATO that indicates a position of a center area of the FATO and adjusting a trajectory of an approach to the FATO based on the information that indicates the position of a center area of the FATO.

In some cases, the information that indicates the position of the center area of the FATO includes a position representation for the aircraft that indicates a position of the aircraft relative to multiple beacons surrounding the center area of the FATO.

### Conclusion

FIGS. 1 and 2 and the components depicted herein (e.g., the guidance system) provide a general computing environment and network within which the guidance system can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network can be any network, ranging from a wired or wireless local area network (LAN), to a wired or wireless wide area network (WAN), to the Internet or some other public or private network. While the connections between the system and other aspects are shown as separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system may reside on a server computer, while corresponding portions may reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order; and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the methods and system provided herein can be applied to other systems, not necessarily the system described above. The elements, blocks and acts of the various implementations described above can be combined to provide further implementations.

Any patents, applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

We claim:

1. A final approach and takeoff area (FATO), comprising:
a touch-down and lift-off (TLOF) area having a center area; and
one or more guidance beacons that transmit information to aircraft proximate to the TLOF area of the FATO.

2. The FATO of claim 1, wherein the one or more guidance beacons include:
an approach beacon configured to transmit information to the aircraft when the aircraft is within a certain distance to the center area of the TLOF area; and
one or more adjustment beacons configured to transmit target information to the aircraft.

3. The FATO of claim 2, wherein the target information includes information that indicates a relative position of the aircraft to the center area of the TLOF area and the one or more adjustment beacons.

4. The FATO of claim 2, wherein the one or more adjustment beacons include a right adjustment beacon and a left adjustment beacon, and wherein the target information includes a position representation that indicates a position of the aircraft relative to the approach beacon, the right adjustment beacon, and the left adjustment beacon.

5. The FATO of claim 1, wherein the one or more guidance beacons include:
multiple adjustment beacons positioned at a peripheral area of the TLOF area and configured to transmit target information to the aircraft.

6. The FATO of claim 2, wherein the target information includes distance information that represents a position of the aircraft with respect to a right side or a left side of a center line of the TLOF area.

7. The FATO of claim 1, wherein the one or more guidance beacons include:
an approach beacon configured to transmit information to the aircraft when the aircraft is within a certain distance to the center area of the TLOF area,
wherein the information includes a unique identifier for the FATO or the TLOF area.

8. The FATO of claim 7, wherein the information includes information associated with a current status of the FATO and navigation lane information associated with an approach to be taken by the aircraft to the center area of the TLOF.

9. The FATO of claim 1, further comprising:
a weather sensor,
wherein the one or more guidance beacons transmit weather information captured by the weather sensor to the aircraft.

10. The FATO of claim 9, wherein the weather sensor is a wind speed sensor, and wherein the weather information includes wind speed information for multiple areas proximate to the center area of the TLOF area.

11. A method performed by a guidance system of a final approach and takeoff area (FATO), the method comprising:
determining that an aircraft approaching the FATO is within a certain distance to a center of the FATO; and
transmitting location information to the aircraft that represents a location of the aircraft relative to the center of the FATO.

12. The method of claim 11, further comprising:
determining an occurrence of an information transmission event at the FATO; and
transmitting updated location information to the aircraft.

13. The method of claim 12, wherein the occurrence of an information transmission event at the FATO includes an event where the aircraft has crossed a distance threshold while approaching the FATO.

14. The method of claim 12, wherein the information transmission event at the FATO includes a commencement of a time period for transmission of updated location information to the aircraft.

15. The method of claim 12, wherein the occurrence of an information transmission event at the FATO includes a change in weather at the FATO.

16. The method of claim 12, wherein the occurrence of an information transmission event at the FATO includes a determination that a current trajectory of the aircraft is outside of an expected trajectory for the aircraft while approaching the FATO.

17. The method of claim 11, wherein the location information includes information that identifies a position of the aircraft to one or more of adjustment beacons positioned at the FATO.

18. The method of claim 11, wherein the guidance system transmits the location information to the aircraft via an approach beacon deployed at a front area of the FATO.

19. A method performed by an aircraft, the method comprising:
receiving information from a beacon of a final approach and takeoff area (FATO) that indicates a position of a center area of the FATO; and
adjusting a trajectory of an approach to the FATO based on the information that indicates the position of a center area of the FATO.

20. The method of claim 19, wherein the information that indicates the position of the center area of the FATO includes a position representation for the aircraft that indicates a position of the aircraft relative to multiple beacons surrounding the center area of the FATO.
